(19) United States
(12) Patent Application Publication
(10) Pub. No.: US 2018/0308655 A1
(43) Pub. Date: Oct. 25, 2018

(54) GENERATION OF AN ULTRASHORT ION BUNCH

(71) Applicant: ECOLE POLYTECHNIQUE, Palaiseau (FR)

(72) Inventors: Gérard MOUROU, Paris (FR); Jonathan WHEELER, Bourg-La-Reine (FR); Toshiki TAJIMA, Foothill Ranch, CA (US); Meilin ZHOU, Beijing (CN); Xuequing YAN, Beijing (CN)

(21) Appl. No.: 15/767,669

(22) PCT Filed: Oct. 14, 2016
(86) PCT No.: PCT/EP2016/074803

§ 371 Date: Apr. 12, 2018

(30) Foreign Application Priority Data
Oct. 14, 2015 (FR) 1559764

(51) Int. Cl. H01J 27/24; H01S 3/11

(52) U.S. Cl. CPC H01J 27/24; H01S 3/11

(57) ABSTRACT

The invention refers to a method for generating an ultrashort ion bunch (22) comprising the steps of emitting a laser pulse (16) whose length is four periods or less, preferably one period, and whose power is 1 PW or more, preferably 10 PW or more; and irradiating a solid target (12) with said laser pulse (16), so as to create an ion bunch (22). The invention also refers to a corresponding system (10) for generating an ultrashort ion bunch (20) comprising the solid target (12), and a laser system (14) for generating the laser pulse (16) and irradiating the solid target (12) with the laser pulse (16), for creating an ion bunch (22).

The present invention refers to a method and a system for the generation by a laser of coherent, low emittance ion bunches of ultrashort duration, i.e. from 10⁻¹² down to 10⁻¹⁵ seconds, and preferably with peak energy higher than 1 MeV.

Different methods have been described for generating ultrashort ion bunches with a laser.

One of these methods is known as the “Target Normal Sheath Acceleration” method (or TNSA).[1]

According to this method, very energetic and hot electrons are generated and driven into a target foil by an intense laser pulse. When they arrive at the rear surface of the target foil, the space charge separation results in a large, electrostatic field that ionizes a thin layer of water vapor that is present under the experimental vacuum conditions. The accelerating electro-static field is directed along the rear surface normal. Protons which have a higher charge to mass ratio, are accelerated quicker than heavy ions. They then shield the accelerating field, suppressing acceleration of heavy ions.

However, TNSA has a large divergence of the ion bunch, resulting in a spectrum for the ions with almost 100% energy spread, and is inefficient in acceleration. Moreover, in TNSA, the ion energy is tied to the energy of spreading electrons that are heated by the injected laser and thus the ion energy gain has a relatively weak laser intensity dependence while it depends on other conditions and parameters too. Here the laser intensity, I, is proportional to a₀² with a₀=e E/mₑ ω c being the normalized vector potential of the laser (or normalized laser field), where E, ω, c, mₑ, and e are the laser electric field, frequency, speed of light in vacuum, electron mass, and charge, respectively.

Another method for generating an ultrashort ion bunch using a laser is known as the “radiation pressure acceleration” method (or RPA).[2] According to this method a circularly polarized laser pulse is focused on a thin foil of 5 to 10 nm thick for fully ionizing the foil. Electrons are then accelerated out of the backside of the foil by the ponderomotive potential of the laser pulse. The attractive electrostatic force between ions and electrons gives rise to a dense electron layer behind the backside of the foil. This dense electron layer is accelerated by the light pressure of the laser. The heavier ions are pulled by the dense electron layer and therefore are accelerated.

The ion energy gain is greater with RPA than with TNSA and the intensity dependence is more favorable such as proportional to from ½ (for a moderate a₀>1) to the first power of the laser intensity (for a₀>>1), while the ion energy spectrum is much narrower than that of TNSA. The efficiency of acceleration is also much higher than that of TNSA. However, the required laser intensity is huge, typically on the order of 10²³ W/cm².

The Coherent Acceleration of Ions by Laser (or CALL) regime[3], on the other hand, requires less laser power than is already currently available. This regime has also an ion energy dependency on the ½ power of the intensity for a₀>>1, though again it depends on other parameters. Moreover, this method also results in a quasi-monoenergetic ion spectrum. Thus CALL sits mechanism-wise and efficiency-wise in between TNSA and RPA.

In many ion acceleration methods, because of the hole boring effects and transverse instabilities such as Rayleigh-Taylor instability, the acceleration is soon terminated, which seriously reduces the acceleration efficiency of ions.

It is an aim of the present invention to provide an improved method which does not have the above mentioned drawbacks. Preferably, the method requires the smallest laser energy beyond any of the regimes before-mentioned. Especially, it is an object of the present invention to provide a method and a system for the generation of an ultrashort ion bunch with an almost mono-energetic ion spectrum.

Moreover, FR-A-3 017 495 discloses a femtosecond laser system with high energy and short pulse duration.

According to a first object, the present invention provides a method for generating an ultrashort ion bunch comprising the steps of:
Emitting a laser pulse whose length is four periods or less, preferably one period, and whose power is 1 PW or more, preferably 10 PW or more; and
Irradiating a solid target with said laser pulse, so as to create an ion bunch.

Throughout this document, single-cycle-like refers to a laser pulse consisting of four or fewer periods of the laser carrier frequency with a particular preference for a single period. Surprisingly, the inventors noted that a single-cycle-like ultrashort pulsed laser irradiation of target produces a high energy, high quality ion bunch. In other words, irradiating a thin solid target with a single cycle pulse enables the generation of an improved ion bunch. Indeed, the suggested method is highly efficient and enables the generation of an instability-free ion bunch. This method also leads to a far sharper mono-energetic spectrum of ions as with the methods of the prior arts. Finally, the inventors noted that the suggested method takes far smaller laser energy than that required in the above mentioned methods of the art.

According to preferred embodiments, the method according to the invention includes one or more of the following features, alone or combined:
said laser pulse length is comprised between 1 fs and 45 fs;
the normalized laser field of said laser pulse a₀ is higher than 1, said normalized laser field being given by the equation a₀=e E/mₑ ω c, where E, ω, c, mₑ, and e are the laser electric field, frequency, speed of light in vacuum, electron mass, and charge, respectively;
the solid target is a foil of 1 nm to 1000 nm thickness;
the solid target is made of CH, glass or metal;
the ratio between the normalized electron areal density in the target, σ, and the normalized laser field of said laser pulse, a₀,

$$σ \text{/} {a}_{0} = \frac{{n}_{e} l}{{n}_{cr} λ {a}_{0}} ,$$

is less than 1, where nₑ is the electron density in the target, n_{cr} is the critical density as defined by the laser pulse wavelength, λ, and l is the thickness of the target; and
said ratio between the normalized electron areal density in the target, σ, and the normalized laser field of said laser pulse, a₀, is comprised between 0.05 and 0.15, said ratio being preferably substantially equal to 0.12.

According to another aspect, the invention refers to a system for generating an ultrashort ion bunch comprising:
a solid target, and
a laser system for generating a laser pulse and irradiating said solid target with said laser pulse for creating an ion bunch, wherein the length of said laser pulse is four periods or less, preferably one period, and the power of said pulse is 1 PW or more, preferably 10 PW or more.

According to preferred embodiments, the system according to the invention includes one or more of the following features, alone or combined:
said laser pulse length is comprised between 1 fs and 45 fs;
the normalized laser field of said laser pulse a₀ is higher than 1, said normalized laser field being given by the equation a₀=e E/mₑ ω c, where E, ω, c, mₑ, and e are the laser electric field, frequency, speed of light in vacuum, electron mass, and charge, respectively;
the solid target is a foil of 1 nm to 1000 nm thickness;
the solid target is made of CH, glass or metal.
the ratio between the electron areal density in the target, σ, and the normalized laser field of said single-cycle-like pulse a₀,

$$σ \text{/} {a}_{0} = \frac{{n}_{e} l}{{n}_{cr} λ {a}_{0}} ,$$

is less than 1, where nₑ is the electron density in the target, n_{cr} is the critical density as defined by the laser wavelength, λ, and l is the thickness of the target; and
said ratio between the normalized electron areal density in the target, σ, and the normalized laser field of said single-cycle-like pulse, a₀, is comprised between 0.05 and 0.15, said ratio being preferably substantially equal to 0.12.

Other features and advantages of the invention will appear more clearly from the following detailed description, based on the appended drawings among which:

FIG. 1 shows schematically an example of system for generating an ultrashort ion bunch;

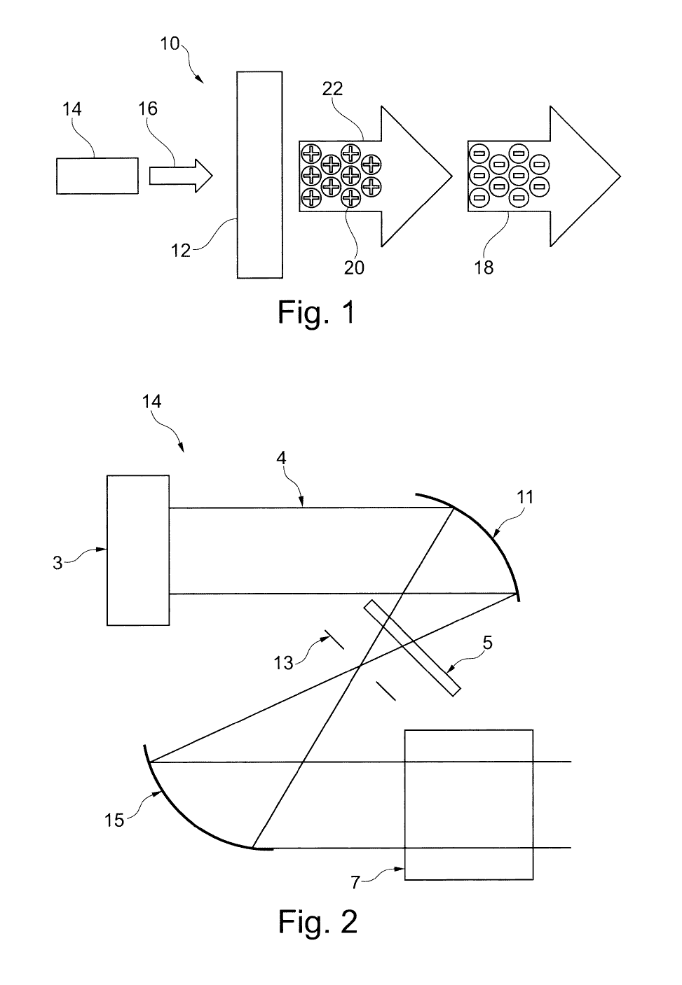

FIG. 2 shows schematically an example of a laser system that can be used in the system of FIG. 1;

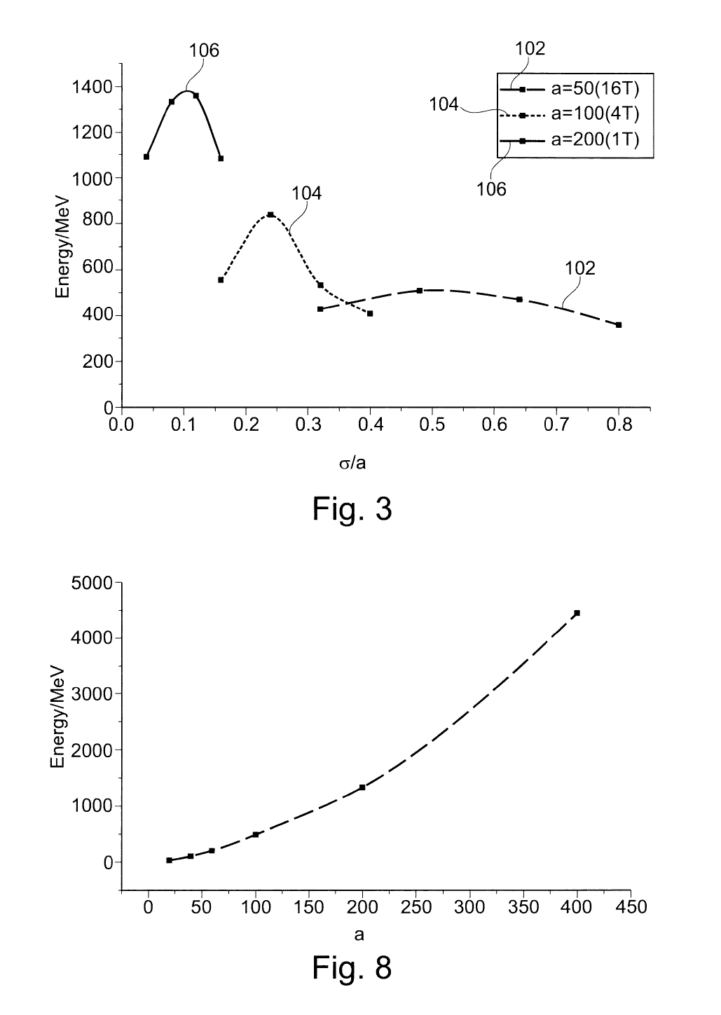

FIG. 3 illustrates the cutoff energy of protons with different ratios of the electron areal density 6 on normalized laser field a₀ and different pulse length of the laser pulses which can be generated using the system of FIG. 1;

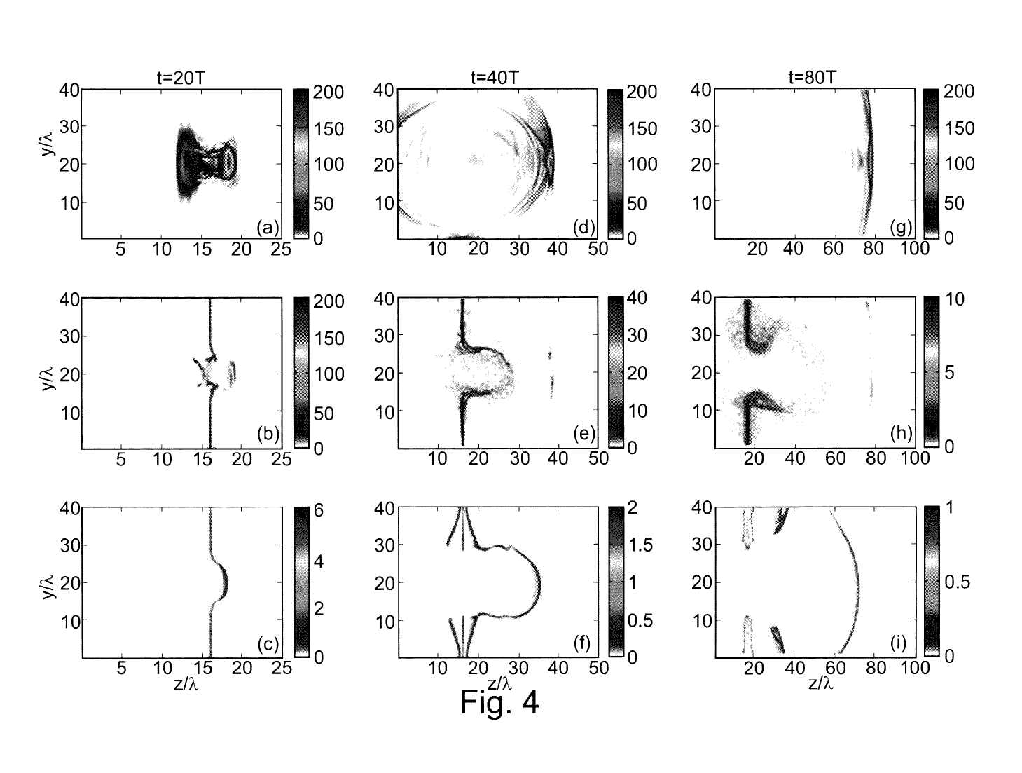

FIG. 4 illustrates transverse electric field, electron density and proton density in a plane transversal to the propagation direction of the protons at different times, said protons being obtained using the system of FIG. 1;

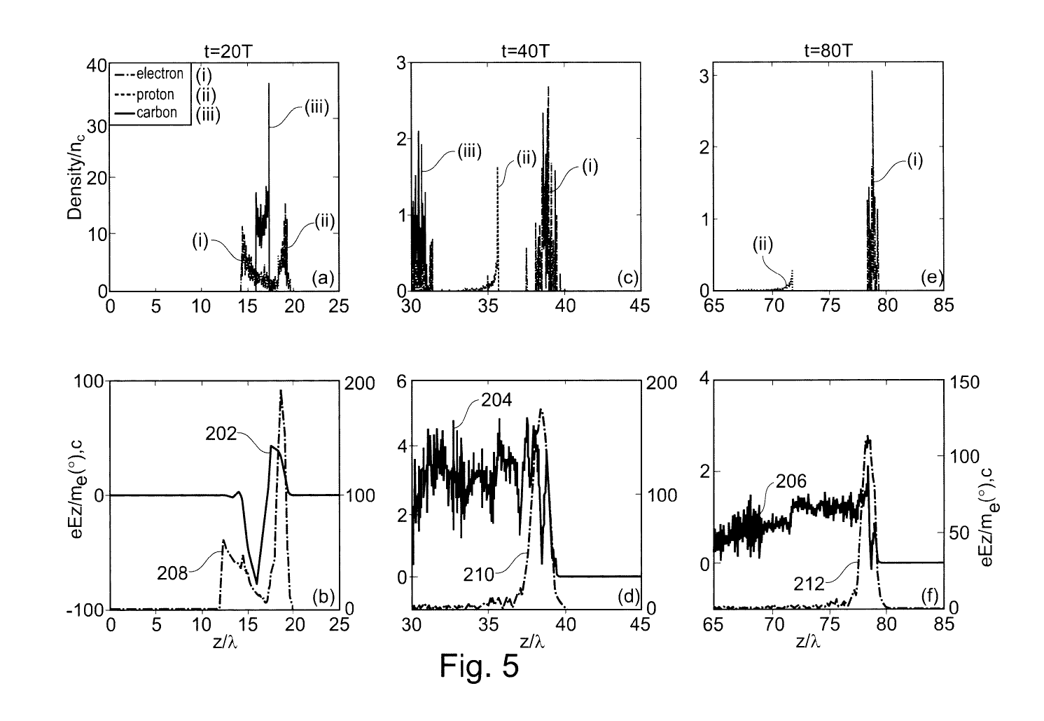

FIG. 5 plots the data of particle densities, longitudinal field, and transverse field as a function of the longitudinal coordinate at different times in the system of FIG. 1.

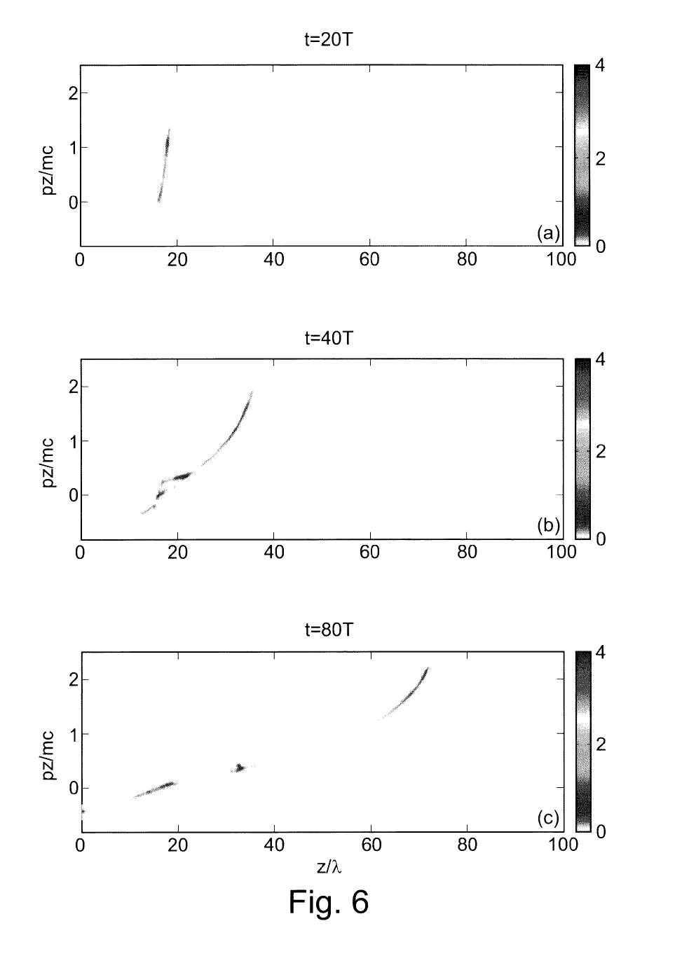

FIG. 6 shows longitudinal phase space map of protons at different times, said protons being obtained using the system of FIG. 1;

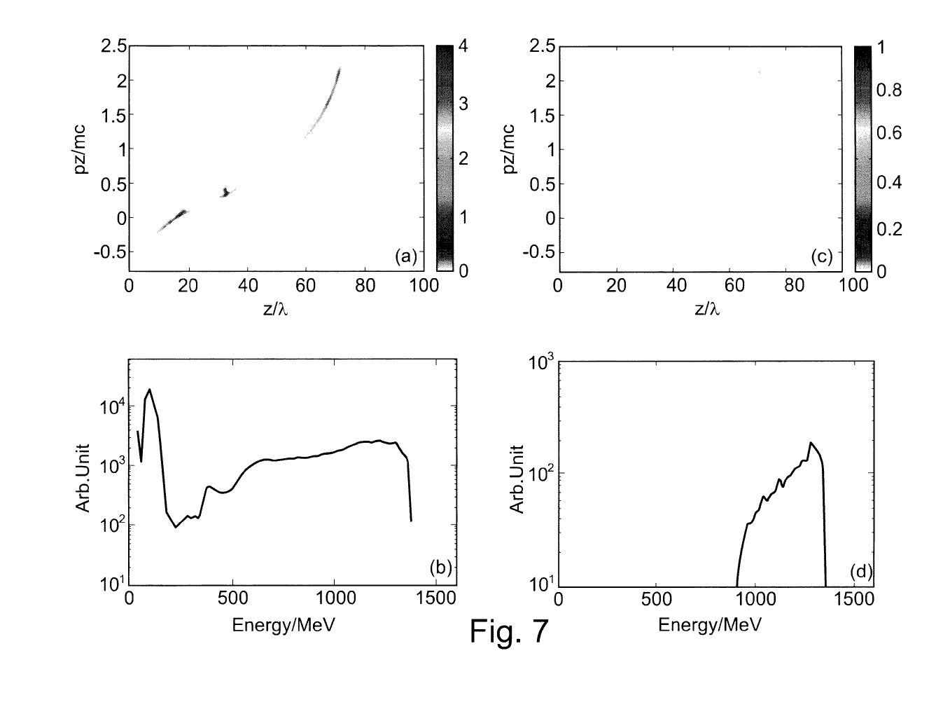

FIG. 7 shows the proton phase map and spectrum respectively in whole space and in the center of the target of the system of FIG. 1; and

FIG. 8 illustrates the proton cutoff energy as a function of a₀ when the system of FIG. 1 is used.

A system 10 for generating an ultrashort proton bunch is shown on FIG. 1.

This system 10 comprised essentially a solid target 12 and a laser system 14 for generating a single-cycle-like laser pulse 16 and irradiating said solid target 12 with said single-cycle-like laser pulse 16.

The laser system 14 can be based on compression of an ultrashort (typically around 25 fs or 10 periods) laser pulse into a single-cycle-like pulse. Such a compression method is known [4], which is based on the compression of a spatial top hat, 30 fs beam by self-phase modulation and group velocity dispersion produced in a thin plastic film. According to this compression method, if a typical Ti:sapphire 1 PW laser at 25 fs is used as well as a two stage compression template, then the thin film compression technique would reduce the initial laser pulse into a single-cycle-like pulse with around 10 PW power and 2.5 fs length.

The single-cycle-like laser pulse 16 may be one to up to four period long. Preferably, the single-cycle-like laser pulse 16 is a single-cycle laser pulse, of one period length.

The single-cycle-like laser pulse may have a power of 1 PW or more, preferably of 10 PW or more.

The single-cycle-like laser pulse may be focused on the front face of the solid target 12 with an intensity of a pulse with an intensity giving a normalized vector potential, a₀, from 10 through 1000. The upper limit is limited only by realistic capabilities of current day laser technology.

The laser pulse duration may be comprised between 1 fs and 45 fs. This duration depends on the frequency of the laser.

The solid target 12 may be a foil of 1 nm to 1000 nm thickness. The solid target 12 may be made of CH, glass or metal.

As shown in FIG. 1, a single-cycle-like Gaussian pulse 16 irradiates the solid target 12 so that the single-cycle-like pulse 16 pushes forward through the ponderomotive force an isolated relativistic electron bunch 18. In turn, ions, especially protons 20, can be accelerated in the longitudinal electrostatic field. With a thin solid target 12, ions 20 can be accelerated over a long distance, stably, without suffering from transverse instabilities. Under this quite stable acceleration structure, a highly mono-energetic ultrashort proton bunch 22 is obtained.

A laser system 14 that may be used in the system 10 of FIG. 1 is described for example in FR-A-3 017 495. FIG. 2 illustrates schematically such a laser system 14. It comprises means 3 for generating an input laser beam providing a femtosecond laser beam 4, with a spatially uniform amplitude and propagating according to an axis. The femtosecond laser beam 4 has an energy greater than 1 Joule.

The system 14 further comprises a transparent plate 5, formed of a transparent sub-millimeter film with thickness for example within the range of 0.1 to 1 mm, positioned secant to the axis of propagation of the laser beam 4, the laser beam 4 having a power density such that it induces a phase self-modulation during the crossing of the laser pulse through the transparent plate 5 so as to generate a wide-spectrum laser pulse.

The system 14 also comprises compression means 7 arranged to compress the wide-spectrum laser pulse so as to generate a short duration laser pulse. The generating means 3 of the input laser beam are adapted so that the pulse has an energy greater than 1 Joule, and the transparent plate 5 is formed of a transparent film

The film 5 may be formed by a continuous process to obtain a thickness less than one millimeter. The film 5 may be composed of at least one of the following materials: amorphous thermoplastic polymers, PVDC, PVC additive, tri acetate cellulose, polyester or glass.

The laser pulse 4 being polarized, the film 5 may be disposed according to a Brewster angle with regard to the axis of propagation of the laser beam 4, so as to minimize the partial reflection of the laser pulse on film. The film 5 may have a thickness less than 1 millimeter and a diameter greater than 15 centimeters. Downstream of the flexible film 5, a wavefront correction device 15 may be disposed for correcting the wavefront shifts generated by thickness irregularities of the film 5. The wavefront correction device 15 may be a deformable mirror.

The input laser beam 4 may be focused by a first mirror 11 having a focal point, said first mirror 11 being positioned between said generating means 3 and the transparent flat plate 5, the transparent plate 5 being positioned between said first mirror 11 and its focal point. The first mirror 11 may be a parabolic mirror. A spatial filter 13 may be positioned at the focal point of the first mirror 11.

A second mirror 15 may be positioned downstream of the focal point of the first mirror 11 and has a focal length suitable for providing to the compression means a broader spectrum pulse having an image at infinity. The second mirror 15 may be a deformable mirror adapted to correct the wavefront variations of the pulse generated by variations in thickness of the flexible film.

It can be noticed that a second stage may be adapted downstream of the compression means. In other words, another first mirror is adapted downwards of the compression means, then another film, possibly another spatial filter, another second mirror and finally another compression means 7. In this latter case, we can refer to a double stage of compression of the laser beam 4.

In the following the quality of the ion bunch obtained with the method described with regard to FIG. 1 is discussed with regard to FIGS. 3 to 8.

First, FIG. 3 illustrates a computational comparison between different cutoff energies of protons with different σ/a₀ ratios where:
σ is the normalized areal electron density of the target, σ=nₑ·l/(n_{cr}λ), where nₑ is the electron density of the target 12, n_{cr} is the critical density as defined by the laser wavelength, λ, and l its thickness, and
a₀ is the normalized laser vector potential (or normalized laser field).

On FIG. 3, different laser pulses are represented which vary with laser field a₀ and pulse duration τ under the same total energy E, where E is proportional to a₀²τ. FIG. 3 thus shows the cutoff energy of protons where:
line 102 corresponds to a laser pulse with a₀=50, and pulse duration τ=16T,
line 104 corresponds to a pulse with a₀=100 and τ=4T, and
line 106 corresponds to a pulse with a₀=200 and τ=1T,
   where T is the laser oscillation period.

As can be seen on FIG. 3, the acceleration efficiency of ions sharply varies with pulse durations. From the three curves 102, 104, 106 one can note that with the higher laser field and shorter pulse duration, in particular with the single-cycle pulse (curve 106), the cutoff energy of ions is increased by a large amount. Another point to be observed in FIG. 3 is that with a single-cycle pulse (curve 106), the most favorable ratio between the electron areal density 6 and normalized laser field a₀, σ/a₀=nₑ·l/(n_{cr}λ a₀) is less than 1, more precisely between 0.05 and 0.15, and even more precisely substantially equal to 0.12. This value is much smaller than the optimal value of this ratio in the traditional RPA acceleration.

Now referring to FIG. 4. This figure illustrates the results of an investigation by two-dimensional particle-in-cell (2D-PIC) simulations (KLAP). In this simulation the circular polarized laser pulse 16 propagates along a z axis in the simulation box with y*z size 40λ*100λ, which contains 800*10000 cells, and each cell is filled with 100 particles. The laser pulse wavelength is λ=1 μm. The single-cycle laser pulse has a Gaussian shape or envelope in transverse direction y with focal spot size r=5λ and also a Gaussian shape or envelope in longitudinal direction z with duration τ=1T. The CH foil target (the density ratio between carbon and hydrogen is 9:1) has a thickness l=0.05λ and a normalized density nₑ=480n_{c}, where n_{c}=(mₑ ω²)/(4πe²) is the critical density. The target is located at z=16λ from the laser system.

FIG. 4 shows:
the evolution of transverse electric field on graphics (a), (d) and (g),
the evolution of densities of electrons on graphics (b), (e) and (h), and
the evolution of protons on graphics (c), (f) and (i),
   at t=20T, 40T, and 80T, respectively.

From graphics (d), (e), (g), (h), one can see that when the single-cycle laser pulse incident on the target, a compressed electron slice is pushed forward by the pulse and goes ahead together with the pulse wavefront along the longitudinal direction. Different from the traditional RPA, graphics (e), (f), (h), (i) show that the acceleration structure is quite stable and does not suffer from the transverse instability. Here, protons are accelerated at a certain distance behind electrons, rather than nearly in the same longitudinal position as in RPA. From graphic (i), one can observe that there are three parts of protons at t=80T, a thin proton slice being formed behind an electron layer. These graphics illustrates that with a Gaussian single-cycle pulse and a simple plane target, the acceleration time is much longer than that reported in the traditional RPA, thus making the acceleration more coherent and requiring less laser energy than the known RPA regime.

FIG. 5 illustrates the data on longitudinal axis of particle density on graphics (a), (c), (e) and the longitudinal electric field (curves 202, 204, 206) and transverse electric field (curves 208, 210, 212) on graphics (b), (d), (f), in the (z, y) plane at time t=20T (graphics (a),(b)), t=40T (graphics (c),(d)) and t=80T (graphics (e),(f)). Just adjacent to the laser pulse wavefront, one can see that the density of relativistic compressed electron bunch is still above the critical density. A stable longitudinal electrostatic field (curves 202, 204 and 206) is formed, which accelerates the isolated proton slice at a distance behind the electrons.

Correspondingly, FIG. 6 shows the longitudinal momentum increase of protons in space at time t=20T (graphic (a)), t=40T (graphic (b)) and t=80T (graphic (c)). A comparison of the phase map and spectrum of protons in the whole space (graphics (a) and (b)) and in the center of the slice of graphic (i) of FIG. 4 (graphics (c) and (d); the center of the target is such that r≤2λ) is shown on FIG. 7. From graphics (c) and (d) on this FIG. 7, one can see the monoenergetic spectrum and the nicely isolated shape of the proton bunch. It can also be observed that the thickness of the central slice is no more than 1 μm, corresponding to an ultrashort proton bunch of a few femtoseconds.

Finally, a cutoff energy scan of the single-cycle laser pulse with ultrathin target acceleration regime from a₀=20 to a₀=400 is shown on FIG. 8 with the fitted scaling law about E∝a₀^{1.67}. This exponent 1.67 (under the domain of a₀>>1) is greater than those found in the cases of TNSA and CALL and rivals that of RPA (for a₀>>1). This is another indication that the present single-cycle pulse acceleration is highly efficient and efficacious.

In conclusion the method and system described above enable the generation of an instability-free ion acceleration regime. This results from the interaction of a single-cycle-like pulse with a thin solid target. With this single-cycle-like pulse, the optimal ratio between electron areal density and normalized laser field σ/a₀ is substantially equal to 0.12 which is much smaller than the optimal value of 0.42 or greater in the traditional RPA. [5]

According to the method described, after the electron bunch is pushed forward by the laser ponderomotive force, ions are effectively accelerated in the stable longitudinal electrostatic field over a long distance. Thus the present method is relatively simplistic and robust, yielding to high quality, ultrashort and high energy ion/proton bunches in a very compact fashion without requiring a large laser energy. In this way a compressed ultrashort proton bunch may be achieved from a standard PW class laser, using a compression stage, for example a Thin Film Compression (TFC) stage as described with regard to FIG. 2.

To increase the repetition rate from Hz to kHz, a high-repetition large power laser may be realized by the fiber laser (called CAN laser)[6]. If one combines the CAN laser with the above described method, highly repetitive ultrashort proton bunches may be obtained. Such proton bunches have broad applications, including extremely compact injectors, medicine (such as proton oncology), high energy physics, and high fluence neutrons such as for the driver of subcritical reactors for ADR and muon beams. Because of the fs time resolution, time sensitive measurements and triggers may become available for the first time.

The invention is not limited to the examples described above. For example, the simulations discussed above take particular species of ions and parameters, which do not limit the scope of the invention which is defined by the appended claims.

### REFERENCES

1. Snavely, R. A., Key, M. H., Hatchett, S. P., Cowan, I. E., Roth, M., Phillips, T. W., Stoyer, M. A., Henry, E. A., Sangster, T. C., Singh, M. S., Wilks, S. C., MacKinnon, A., Offenberger, A., Pennington, D. M., Yasuike, K., Langdon, A. B., Lasinski, B. F., Johnson, J., Perry, M. D., and Campbell, E. M. “Intense High-Energy Proton Beams from Petawatt-Laser Irradiation of Solids” Physical Review Letters 85, no. 14 (2000): 2945-2948. doi:10.1103/PhysRevLett.85.2945,
2. Esirkepov, T., Borghesi, M., Bulanov, S. V., Mourou, G., and Tajima, T. “Highly Efficient Relativistic-Ion Generation in the Laser-Piston Regime” Physical Review Letters 92, no. April (2004): 175003-1. doi:10.1103/PhysRevLett.92.175003,
3. Tajima, T., Habs, D., and Yan, X. Q. “Laser Acceleration of Ions for Radiation Therapy” Reviews of Accelerator Science and Technology: Medical Applications of Accelerators no. v. 2 (2009): 201-228. Available at https://books.google.fr/books?id=gj4cOFvFhvgC
4. Mourou, G., Mironov, S., Khazanov, E., and Sergeev, a. “Single Cycle Thin Film Compressor Opening the Door to Zeptosecond-Exawatt Physics” The European Physical Journal Special Topics 223, no. 6 (2014): 1181-1188. doi:10.1140/epjst/e2014-02171-5, Available at http://link.springer.com/10.1140/epjst/e2014-02171-5
5. Esirkepov, T., Yamagiwa, M., and Tajima, T. “Laser Ion-Acceleration Scaling Laws Seen in Multiparametric Particle-in-Cell Simulations” Physical Review Letters 96, no. 10 (2006): 105001. doi:10.1103/PhysRevLett.96.105001, Available at http://link.aps.org/doi/10.1103/PhysRevLett.96.105001
6. Mourou, G., Brocklesby, B., Tajima, T., and Limpert, J. “The Future Is Fibre Accelerators” Nature Photonics 7, no. April (2013): 258-261. Available at http://dx.doi.org/10.1038/nphoton.2013.75

1. Method for generating an ultrashort ion bunch comprising the steps of:
Emitting a laser pulse whose length is four periods or less, and whose power is 1 PW or more, and
Irradiating a solid target with said laser pulse, so as to create an ion bunch.

2. Method according to claim 1, wherein said laser pulse length is comprised between 1 fs and 45 fs.

3. Method according to claim 1, wherein the normalized laser field of said laser pulse a₀ is higher than 1, said normalized laser field being given by the equation a₀=e E/mₑ ω c, where E, ω, c, mₑ, and e are the laser electric field, frequency, speed of light in vacuum, electron mass, and charge, respectively.

4. Method according to claim 1, wherein the solid target is a foil of 1 nm to 1000 nm thickness

5. Method according to claim 1 to wherein the solid target is made of CH, glass or metal.

6. Method according to claim 1, wherein the ratio between the normalized electron areal density in the target σ and the normalized laser field of said laser pulse a₀,
$$σ \text{/} {a}_{0} = \frac{{n}_{e} l}{{n}_{cr} λ {a}_{0}} ,$$
is less than 1, where nₑ is the electron density in the target, n_{cr} is the critical density as defined by the laser pulse wavelength, λ, and l is the thickness of the target.

7. Method according to claim 6, wherein said ratio between the normalized electron areal density in the target σ and the normalized laser field of said laser pulse a₀ is comprised between 0.05 and 0.15.

8. System for generating an ultrashort ion bunch comprising:
a solid target, and
a laser system for generating a laser pulse and irradiating said solid target with said laser pulse for creating an ion bunch, wherein the length of said laser pulse is four periods or less, and the power of said pulse is 1 PW or more.

9. System according to claim 8, wherein said laser pulse length is comprised between 1 fs and 45 fs.

10. System according to claim 8, wherein the normalized laser field of said laser pulse a₀ is higher than 1, said normalized laser field being given by the equation a₀=e E/mₑ ω c, where E, ω, c, mₑ, and e are the laser electric field, frequency, speed of light in vacuum, electron mass, and charge, respectively.

11. System according to claim 8, wherein the solid target is a foil of 1 nm to 1000 nm thickness.

12. System according to claim 8, wherein the solid target is made of CH, glass or metal.

13. System according to claim 8, wherein the ratio between the electron areal density in the target σ and the normalized laser field of said single-cycle-like pulse a₀,
$$σ \text{/} {a}_{0} = \frac{{n}_{e} l}{{n}_{cr} λ {a}_{0}} ,$$
is less man 1, where nₑ is the electron density in the target, n_{cr} is the critical density as defined by the laser wavelength, λ, and l is the thickness of the target.

14. System according to claim 13, wherein said ratio between the normalized electron areal density in the target σ and the normalized laser field of said single-cycle-like pulse a₀ is comprised between 0.05 and 0.15.
